(19) United States
(12) Patent Application Publication
(10) Pub. No.: US 2026/0348424 A1
(43) Pub. Date: Nov. 5, 2026

(54) CONNECTING ROD COMPRISING A BALL PIVOT

(71) Applicant: VOSGES TECHNOLOGIE INNOVATION & INDUSTRIE, RAMONCHAMP (FR)

(72) Inventors: Jean-Charles WATRIN, Remiremont (FR); Nils TIBERI, Rehaupal (FR); Arthur DURAND, Hadol (FR); Olivier FRANCOIS, Rochesson (FR)

(21) Appl. No.: 19/487,590

(22) PCT Filed: May 24, 2024
(86) PCT No.: PCT/IB2024/055097

§ 371 Date: Nov. 25, 2025

(30) Foreign Application Priority Data
May 25, 2023 (FR) 2305203

(51) Int. Cl. F16C 11/06; F16C 7/02

(52) U.S. Cl. CPC F16C 11/0695; F16C 7/02; F16C 11/0657; F16C 2220/40; F16C 2220/70; F16C 2220/84; F16C 2226/34

(57) ABSTRACT

An articulation includes a ball pivot, a bearing, and a support rod, the ball pivot including a spherical end and a stud extending from the spherical end. The bearing is configured to house the spherical end of the pivot. Additionally, the support rodincludes a body and an annular head formed by bending one end of the rod, wherein the annular headincludes a cylindrical central recess configured to receive the bearing.

### TECHNICAL FIELD OF THE INVENTION

The invention relates to the field of ball joint articulations allowing a pair of elements to be assembled in such a way as to allow a relative pivoting movement of the pair of elements and, more specifically, it relates to a ball joint articulation of simple design which is mechanically strong and which is able to be manufactured at reduced manufacturing costs.

### PRIOR ART

A ball joint articulation of this kind, more specifically an articulation with two ball joints, commonly called a connecting rod, is conventionally used to pivotably connect, for example, the shock absorber bracket and the anti-roll bar of an automobile.

Document DI (US5855447) describes such a ball joint articulation which comprises: —a ball pivot, for connection to a first element, the ball pivot comprising a spherical head and a stud extending from the spherical head for connection to the first element, —a ball seat configured to accommodate the spherical head of the ball pivot, and a support rod, one end of which is shaped as an annular head for receiving the ball seat. The support rod is a metal rod with a round cross section, one end of which is bent to form an annular head. The ball seat is made of elastomeric material and has, on an outer surface, a circular collar which, after assembly, forms a stop for the ball seat against a toroidal surface of the annular head. Compared to articulations of the prior art, the document presents a solution in which the production of the rod is facilitated by the use of a bent wire.

However, such a joint has disadvantages. In practice, it has been found that the mechanical hold of the ball seat in the annular head is not perfect and, during movements of the ball joint, results in friction at the contact zone between the collar of the ball seat and the toroidal surface of the annular head. This phenomenon can create parasitic movements in the connecting rod and can generate noise phenomena, which are harmful when using the product incorporating the connecting rod. This also results in premature wear of the ball seat. Moreover, for the mechanical assembly to hold properly, the edge of the collar of the ball seat must be able to come to bear on the toroidal surface of the annular head which receives the ball seat. The shape and dimensions of the ball seat must therefore be adapted to the diameter of the bent wire and to the internal diameter of the annular head formed at the end of the rod. Thus, the head of the rod must be adapted to the ball seat, and vice versa. This complicates the technical development of the articulations and increases their manufacturing cost.

### DISCLOSURE OF THE INVENTION

The invention proposes a novel ball joint articulation which avoids all or some of the drawbacks of the rod and ball joint described above.

To this end, the invention proposes a ball joint articulation comprising a ball pivot (30), a ball seat and a support rod (40),
the ball pivot (30) comprising a spherical head (31) and a stud (32) extending from the spherical head,
the ball seat (20) being configured to accommodate the spherical head (31) of the pivot, and
the support rod (40) comprising a body (41) and an annular head (42) formed by the bending of one end of the rod (40),
the articulation being characterized in that the head (42) comprises a cylindrical central recess (43) configured to receive the ball seat.

The contact zone between the head of the rod and the body of the ball seat is thus generally cylindrical. Tests have shown that a cylindrical recess makes it possible to obtain optimal distribution of the contact pressures between the spherical head of the pivot, the ball seat and the annular head, as will be seen more clearly below; this limits premature wear of the ball seat. In addition, a recess of cylindrical shape prevents any unwanted rotation of the ball seat in the head of the rod on an axis parallel to a median plane of the head. Friction between the ball seat and the head is thus greatly reduced; the mechanical hold of the ball seat in the annular head is thus improved.

The annular head (42) can also comprise a flat outer bearing surface (44) extending in a plane that intersects an axis (Ac) of the recess (43). The bearing surface will be able to serve as a stop for a collar of the ball seat in order to facilitate the placement of the ball seat, and it improves the resistance to tearing-out of the pivot, as will be seen more clearly below.

In addition, the bearing surface can have a textured surface state. Thus, after the ball seat has been placed in the recess, a rotation of the ball seat along the axis of the recess is prevented, even under extreme conditions of use of the articulation.

More preferably, the head is made so that, after assembly of the ball joint articulation, a continuation of a longitudinal axis Ax of the body (41) of the rod (40) passes through a center (Cs) of the spherical head (31) of the ball pivot (30). This improves the mechanical hold of the assembly, in particular the buckling and fatigue strength of the assembly.

Moreover, in order to improve the mechanical hold of the head, a free end (40a) of the rod (40) can be secured, for example by welding or brazing, to the body (41) of the rod so that the head (42) forms a closed ring.

In the ball joint articulation (10), preferably, the ball seat comprises an interior space (21) whose spherical shape and dimensions are adjusted to receive the spherical head (31) of the pivot (30); the ball seat comprises an opening (22) shaped to allow insertion of the spherical head (31) of the pivot, and the ball seat comprises a cylindrical outer surface (23); and the cylindrical central recess (43) of the head (42) of the rod has dimensions suitable for receiving the ball seat.

Finally, the invention relates to a method for producing a ball joint articulation as described above, comprising a ball pivot (30), a ball seat (20) and a support rod (40), the method comprising the following steps:
a step of bending one end of a wire of circular cross section in order to form the rod 40 comprising an annular head 42 at one end of a body 41,
a step of stamping the head (42) in order to form a flat outer bearing surface (44) configured to serve as a stop for a collar (24) of the ball seat, and
a step of grinding the annular head 42 in order to form a cylindrical central recess 43 configured to receive the ball seat of the ball joint articulation.

### PRESENTATION OF THE FIGURES

The invention will be better understood, and other features and advantages of the invention will become apparent, from the following description of an example of implementation of the invention. This example is given as a non-limiting example. The description should be read in conjunction with the accompanying drawings in which:

FIG. 1 is a perspective view of a ball joint articulation according to the invention

FIG. 2 is a top view of a support rod according to the invention, at an intermediate stage of production

FIG. 3 is a front view of a support rod according to the invention, at another intermediate stage of production

FIG. 4 is a top view of a support rod according to the invention, in its final version

FIGS. 5 to 7 are schematic views of steps in the assembly of the ball joint articulation of FIG. 1, and

FIGS. 8 to 9 show test results for different support rod shapes.

### DETAILED DESCRIPTION

As previously stated, the invention relates to a ball joint articulation.

The example illustrated more particularly shows an articulation with two ball joints, such as a connecting rod adapted to connect the shock absorber bracket and the anti-roll bar of an automobile. More generally, the ball joint articulation is arranged to connect a first element and a second element in such a way as to allow a relative pivoting movement of the two elements with respect to each other. Other applications of the invention are of course possible, for an articulation with a single ball joint or with two ball joints.

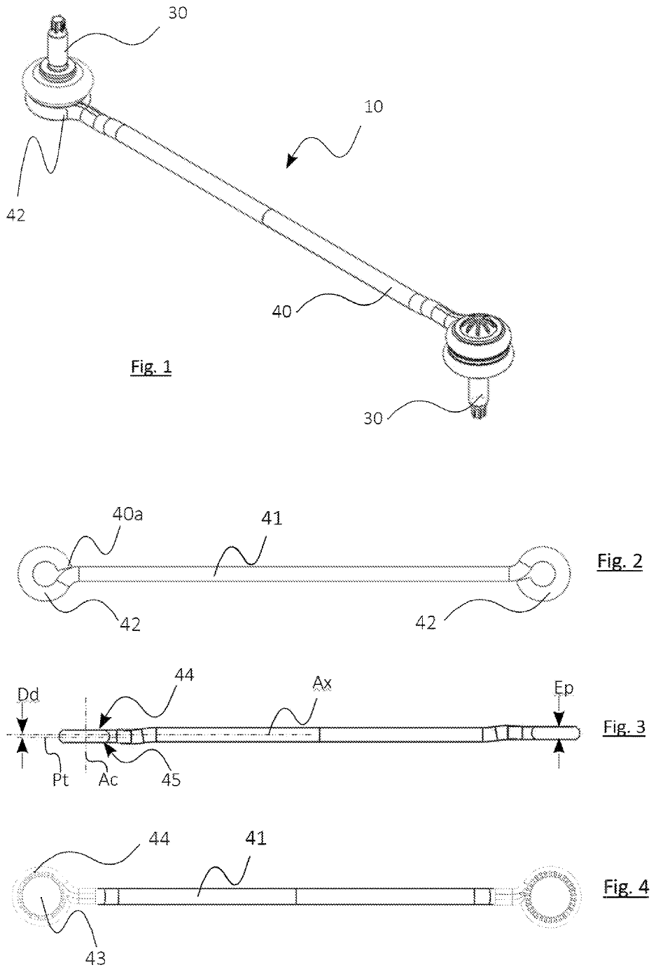

Hereinafter, although FIGS. 1-4 show a rod 40 and a ball joint articulation with two heads 42, only one end of the rod 40 and of the articulation 10 are described, it being possible for the second end to be identical to the first.

The ball joint articulation conventionally comprises:
a ball pivot 30 comprising a spherical head 31 and a stud 32 extending from the spherical head;
a ball seat 20 (also called a cage) configured to accommodate the spherical head 31 of the pivot, and
a support rod 40 comprising a body 41 and an annular head 42 (also called a housing or box).

In a manner known per se, the stud 32 allows connection to the first element via a connection means, for example a threaded free end (FIGS. 1 and 6). The ball pivot 30 is conventionally made of metal, for example steel.

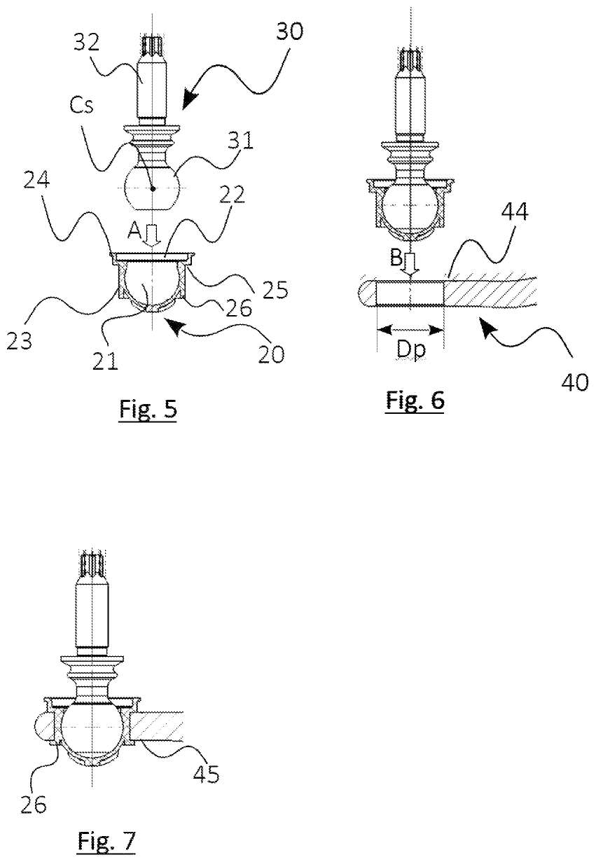

The ball seat 20 comprises (FIGS. 5-6) an interior space 21 whose spherical shape and dimensions (in particular an internal diameter) are suitable for receiving the spherical head 31 of the pivot 30 with a snug fit; the ball seat comprises an opening 22 shaped to allow insertion of the spherical head 31 of the pivot; in the context of the invention, the ball seat comprises a cylindrical outer surface 23, a collar 24 extending from one end of the outer surface 23, and a rib 26 extending from another end of the surface 23. The collar 24 comprises a flat edge 25 extending from the outer surface 23; the edge 25 forms a stop, as will be seen more clearly below. The rib 26 is used for crimping the ball seat, as will be seen more clearly below. The ball seat is made of a thermoplastic polymer, for example polyoxymethylene or polyamide. Such a material is slightly elastic, which facilitates insertion of the spherical head of the pivot into the ball seat. Moreover, the physical properties of such a material allow the ball seat to be crimped into the head of the rod.

The body 41 allows connection to the second element via a connection means, here a second head 42, coupled to a second ball seat 20 and a second pivot 20 (FIG. 1).

According to the invention, the rod 40 is formed by bending one of its ends 40a, in order to form the annular head 42 at the end of the body 41 of the rod 40. In the example shown, the head 42 (and even the two heads 42) extends in a plane parallel to an axis of the body 41 of the rod. As a variant, the head 42 can extend in a plane that intersects the axis of the body 41. As a further variant, the two heads of the same rod can extend in parallel planes or intersecting planes.

Moreover, the head 42 comprises a cylindrical central recess 43 configured to receive the ball seat. The recess is produced by grinding the head 42, preferably by grinding a central part of the annular head, along an axis Ac of symmetry of the head. The grinding can be carried out by machining, boring, drilling, punching or any other technique allowing a cylindrical cavity to be formed with precision. The diameter of the recess is adjusted to the diameter of the outer surface 23 of the ball seat. The cylindrical central recess allows a snug fit of the ball seat in the head of the rod, with a large contact surface between a cylindrical wall of the recess 43 and the outer surface 23 of the ball seat, i.e. a fit that ensures a perfect hold of the ball seat.

Tests have shown that the cylindrical shape for the central recess of the rod is the most effective for maximizing the mechanical performance of the ball seat.

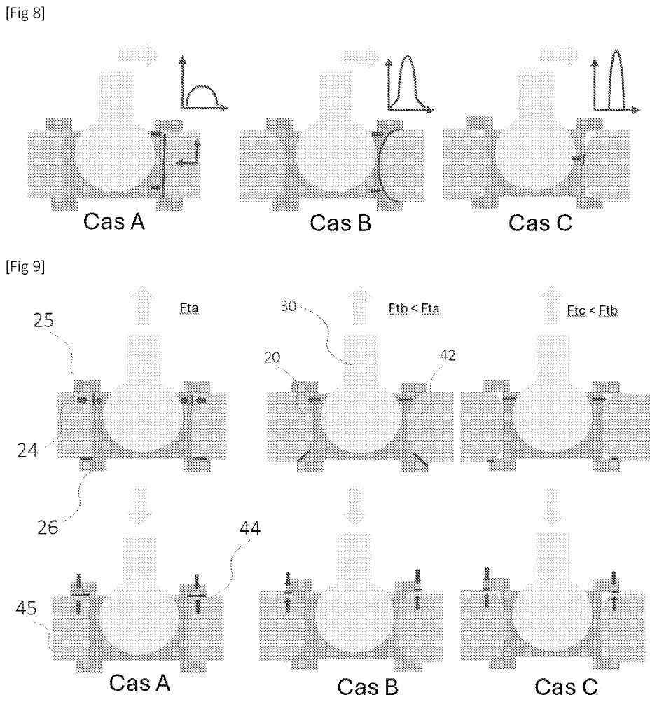

FIG. 8 shows results of tests carried out on three embodiments A, B and C of a ball joint articulation, when a pushing force is applied to the pivot 30 in a direction (gray arrow) parallel to a principal plane of the head 40 of the rod. For these three embodiments, A (invention), B and C, the figure shows the distribution of the pressure exerted on the wall of the central recess of the head in a direction parallel to the axis of the cylindrical central recess.

In the case of a toric central recess and of a ball seat having a cylindrical outer surface (Case C), the contact zone between the ball seat and the toric recess is very small and is limited to the equator (or mid-height) of the ball seat. All the mechanical forces transmitted by the pivot via the ball seat are concentrated on this contact zone of very limited dimensions and are therefore very considerable. In the case of a toric central recess and of a ball seat having an outer surface that is also toric (Case B), the contact zone between the ball seat and the central recess is maximum. However, a distribution of the mechanical forces is noted that has a peak at the equator of the ball seat. On the edges, the thickness of the ball seat wall is at its greatest; thus, under pressure, the edges of the ball seat deform less and transmit less force to the toric surface of the head. Conversely, at the equator of the ball seat, where the thickness of the ball seat wall is at its smallest, the wall of the ball seat deforms more and transmits more pressure forces to the wall of the central recess of the head.

In the case of a cylindrical central recess and of a ball seat having an outer surface that is also cylindrical (Case A), the contact zone between the ball seat and the central recess is maximum and the thickness of the wall of the ball seat is constant; the distribution of the forces on the inner surface of the central recess of the head is more regular and does not have a central peak. It is thus possible to minimize the thickness of the wall of the ball seat while maximizing the mechanical performance of the ball seat.

Preferably, a free end 40a of the rod 40 is secured to the body 41 of the rod so that the head 42 forms a closed ring, more resistant to mechanical stresses. This can be done by welding or brazing.

Moreover, the annular head 42 can here comprise a flat outer bearing surface 44 extending in a plane intersecting (in the example shown a plane perpendicular to) the axis Ac of the recess 43. The bearing surface 44 is configured to serve as a stop for the edge 25 of the collar 24 of the ball seat during assembly of the ball joint articulation (FIG. 6), as will be seen more clearly below.

In the example shown, the head 42 also comprises a second bearing surface 45, which can serve as a support for immobilizing the ball seat on the annular head 42. For this purpose, the ball seat can comprise, on the side opposite the opening 22, a rib 26 configured such that, after placement of the ball seat in the recess 43 (FIG. 6), it is deformed (FIG. 7) for example by a crimping technique, in order to crimp the ball seat on the annular head 42 of the rod. The deformation is facilitated by the fact that the ball seat is made of thermoplastic material.

Also in the example shown, the two surfaces 44, 45 are flat and parallel, and parallel to the axis of the body 41; alternatively, they can also have a textured surface state; for example, in FIG. 4, different surface states are shown on the surface 44 of the two heads 42 of the rod. In one example, the two surfaces 44, 45 are produced by crushing the annular head using a stamping technique, as will be seen more clearly below. Moreover, one and/or the other of the surfaces 44, 45 can have a textured surface state.

FIG. 9 shows results of tear-out resistance tests carried out on the three above embodiments A (invention), B and C upon pulling (upward arrows Fta, Ftb, Ftc) or pushing (downward arrows).

In the case of a toric central recess and of a ball seat having a cylindrical outer surface, a flat collar 24 and a flat rib 26 perpendicular to the axis of the cylindrical outer surface (Case C), the contact zone between the ball seat and the toric recess is very small: it is limited to the equator (mid-height) of the ball seat, to one end of the edge 25 of the collar 24 of the ball seat and to one end of the rib 26. When the pivot is pushed, the retention of the ball seat in the recess of the head is reduced to the contact zone at the edge 25 and is therefore very limited. During traction, the free space under the collar 24, between the toric wall of the recess of the head and the wall of the ball seat, allows a deformation of the ball seat so that the pivot is not retained in the ball seat, and the retention of the ball seat in the recess of the head is very limited. In the case of a toric central recess and of a ball seat having an outer surface that is also toric (Case B), the thickness of the wall of the ball seat which participates in the tearing function in the vicinity of the collar 24 is greater. This reduces the resistance to tearing (traction) of the ball seat. Moreover, during pushing of the pivot, only the edge 25 of the collar 24 exerts a retaining force, so that the resistance to the pushing is quite limited.

In the case of a cylindrical central recess and of a ball seat having an outer surface that is also cylindrical (Case A), in the event of traction of the pivot the contact between the ball seat and the central recess under the collar 24 prevents extraction of the pivot from the ball seat, and the contact of the rib 26 on the flat surface 45 of the head of the rod prevents extraction of the ball seat from the head of the rod. In the event of pushing, the contact of the collar 24 on the flat surface 44 prevents ejection of the ball seat from the head of the rod.

As the mechanical properties of the polymer from which the ball seat is made are less important than those of the head of the rod, the tests show that the resistance to tearing of the pivot in cases B and C is reduced by more than 30% compared to case A, the case of the invention.

The thickness Ep of the head 42, that is to say here the distance between the two flat surfaces 44, 45, is chosen by tests to find the best compromise for obtaining a desired mechanical resistance, using the least possible material, and for a minimized cost. It should be noted that the thickness Ep of the head 42 and the diameter Dp of the recess 43 are here decorrelated from the diameter of the wire used to form the rod 40. Thus, it is possible to produce rods 40 from wires of different diameters (depending on the mechanical strength desired for the body 41 in particular), having heads 42 of the same thickness Ep and the same recess diameter Dp, which then makes it possible to use the same ball seats. This facilitates the overall production of the articulations and reduces their manufacturing cost.

Preferably, according to another aspect of the invention, a rod according to the invention is such that, after assembly of the ball join articulation, continuation of a longitudinal axis Ax of the body 41 of the rod passes through a center Cs of the spherical head 31 of the ball pivot 30. This can be obtained for example by a stamping step, during which the median plane of the head is offset. In the particular case shown, the longitudinal axis Ax of the body 41 of the rod 40 is parallel to the median plane Pt of the annular head 42 (the head 42 is thus parallel to the axis Ax of the body), and a distance Dd between the longitudinal axis of the body and the median plane of the head is chosen so that, after assembly of the ball joint articulation, a continuation of the longitudinal axis of the body of the rod passes through a center Cs of the spherical head 31 of the ball pivot 30. This reinforces the mechanical resistance of the connecting rod. The median plane of the head 42 is parallel to the surfaces 44, 45 and equidistant from these surfaces. In the example shown, it is also perpendicular to the axis Ac.

Finally, as previously stated, although only one head 42 of the rod has been described above, the rod shown comprises two annular heads, each formed by the bending of each of the ends of the rod. The rod shown is thus symmetrical and is suitable for connection to two separate elements.

The rod according to the invention and as described above can be made from a metal wire in the following manner. The formation of a single head 42 is described, but two heads, one at each end of the rod, can of course be formed in a similar manner, either simultaneously or successively depending on the tools used.

First, a bending step is performed (FIG. 2): one end of a wire of circular cross section is bent to form the rod 40 comprising an annular head 42 at one end of a body 41.

A stamping (or pressing or crushing) step is then performed in order to press the head 42 and form one or two outer bearing surfaces 44, 45 of the head 42. Another stamping step is performed in order to offset the median plane Pt of the head 42 relative to a longitudinal axis Ax of the body 41 of the rod 40 (offset in a parallel plane or a plane intersecting the axis Ax). Another stamping step can be performed in order to texture the surface state of the bearing surface(s) 44, 45. Depending on the tools available, the stamping steps can be performed successively or simultaneously (a single stamping step to simultaneously obtain flattening and to texturize the flattened surface). The result of the stamping steps is shown in FIG. 3.

A welding or brazing step can then be performed in order to secure the bent end of the rod 40 to the end of the body 41 of the rod and thus close the annular head 42.

Finally, a step of grinding the annular head 42 is carried out: the cylindrical central recess 43 is ground in order to form the cylindrical housing intended to receive the ball seat (FIG. 4).

It should be noted that, of the steps described above, only the bending and grinding steps are essential for implementing the invention. The other steps of stamping and welding/brazing improve the hold of the ball seat and the overall mechanical strength of the final ball joint articulation; they are not essential; they can be considered alone or separately. Similarly, the steps of stamping, welding and grinding can be considered in an order different than the order described above. However, the grinding step will preferably be carried out at the end in order to obtain a cylindrical central recess of optimal quality.

The ball joint articulation 10 according to the invention and as described above can finally be assembled in the following manner, described in connection with FIGS. 5 and 6. Here once again, the assembly of one ball joint is described, although two ball joints, one at each end of the rod, can of course be assembled in a similar manner, either simultaneously or successively depending on the tools used.

The spherical head 31 of the pivot 30 is first inserted into the ball seat 20 (arrow A, FIG. 5). Then the ball seat is introduced into the annular head 42 of the rod, until the flat edge 25 of the collar 24 of the ball seat comes into abutment against the flat outer surface 44 of the head 42 (arrow B, FIG. 6). Finally, the rib 26 of the ball seat 23 is crimped (or riveted) against the bearing surface 25 in order to crimp the ball seat in the recess 43 of the head of the rod 40.

Texturing of the surface state makes it possible to improve the robustness of the contact between the collar or rib of the ball seat on the one hand and the head of the rod.

The support and the contact between the ball seat and the annular head of the rod is achieved in 3 separate zones: the upper face, the cylindrical recess, and the lower part of the head of the rod. In an articulation according to the invention, the ball joint (or spherical mechanical connection) is provided by the spherical head of the pivot and the inner surface of the ball seat. An additional rotation of the ball seat in the head of the rod is not desired because it leads to premature wear of the ball seat, which reduces the internal stresses of the ball joint; this reduction in stresses accelerates premature damage to the ball seat and thus its end of life.

The crimping (or riveting—see above) of the ball seat on the head of the rod aims to inhibit this additional rotation of the ball seat in the head of the rod. This is effective at room temperature. However, tests carried out at −40 °C show the persistence of this phenomenon of additional rotation at low temperature, due to structural modifications at low temperature of the polymer material from which the ball seat is made. The addition of texturing on at least one of the flat surfaces 44, 45 of the head of the rod increases the friction torque, because the ball seat preforms in the texturing during crimping.

### LIST OF REFERENCE SIGNS

10: ball joint articulation
20: ball seat
   21: interior space
   22: opening
   23: outer surface
   24: collar
   25: edge of the collar
   26: rib
30: pivot
   31: spherical head
   32: stud
40: support rod
   40a: end
   41: body
   42: annular head
   43: recess
   44: first bearing surface
   45: second bearing surface
Ax: longitudinal axis of the body 41
Pt: median plane of the head 42
Dd: distance between the longitudinal axis and the median plane
Cs: center of the spherical head
Ep: thickness of the head 42
Dp: diameter of the recess 43

1. An articulation comprising a ball pivot, a ball seat, and a support rod,
wherein the ball pivot includes a spherical head and a stud extending from the spherical head,
wherein the ball seat is configured to accommodate the spherical head of the pivot, and
wherein the support rod includes a body and an annular head formed by bending one end of the support rod, and
wherein the annular head comprises a cylindrical central recess configured to receive the ball seat.

2. The articulation according to claim 1, wherein the annular head comprises a flat outer bearing surface extending in a plane that intersects an axis of the recess.

3. The articulation as claimed in claim 2, wherein the bearing surface has a textured surface state.

4. The articulation according to claim 1, wherein, after assembly of the ball joint articulation, a continuation of a longitudinal axis Ax of the body of the rod passes through a center of the spherical head of the ball pivot.

5. The articulation according to claim 1, wherein a free end of the support rod is secured by welding or brazing to the body of the support rod so that the head forms a closed ring.

6. The articulation according to claim 1, comprising two annular heads, each formed by the bending of each of the ends of the support rod.

7. The articulation according to claim 1, wherein the ball seat comprises an interior space whose spherical shape and dimensions are adjusted to receive the spherical head of the pivot, wherein the ball seat comprises an opening shaped to allow the insertion of the spherical head of the pivot, wherein the ball seat comprises a cylindrical outer surface, and wherein the cylindrical central recess of the head of the support rod has dimensions suitable for receiving the ball seat.

8. The articulation according to claim 7, wherein the annular head of the support rod comprises a flat outer surface in a plane that intersects an axis of the recess, and wherein the ball seat comprises a circular collar extending from the cylindrical outer surface of the ball seat and comprising a flat edge configured to come into abutment against a flat outer surface of the annular head of the support rod during assembly of the articulation.

9. A method for producing a ball joint articulation comprising a ball pivot, a ball, and a support rod the method comprising the following steps:
a step of bending one end of a wire of circular cross section in order to form the support rod, the support rod comprising a body and an annular head at one end of the body,
a step of stamping the annular in order to form a flat outer bearing surface configured to serve as a stop for a collar of the ball seat, and
a step of grinding the annular head in order to form a cylindrical central recess configured to receive the ball seat of the ball joint articulation.

10. The method according to claim 9, also comprising a welding or brazing step for securing the bent end of the rod to the end of the body of the support rod.

11. The method according to claim 9, also comprising a step of texturing a surface state of the bearing surface.

12. The method as claimed in any one of claims 9 to 11, also comprising a stamping step in order to offset a median plane of the head relative to a longitudinal axis of the body of the rod.
